(19) United States
(12) Patent Application Publication
(10) Pub. No.: US 2003/0080538 A1
(43) Pub. Date: May 1, 2003

(54) Multi-purpose deer-hunting cart

(76) Inventors: Benjamin H. Watts, Springboro, OH (US); John E. Fowler, Centerville, OH (US); David Gunter, Kettering, OH (US)

Correspondence Address: STEVENS DAVIS MILLER & MOSHER, LLP, 1615 L STREET, NW, SUITE 850, WASHINGTON, DC, 20036, US

(21) Appl. No.: 10/270,275

(22) Filed: Oct. 15, 2002

Related U.S. Application Data
(63) Continuation-in-part of application No. 09/616,050, filed on Jul. 13, 2000.
(60) Provisional application No. 60/154,829, filed on Nov. 12, 1999.
(60) Provisional application No. 60/328,707, filed on Oct. 12, 2001.

(51) Int. Cl. B62B 1/20

(52) U.S. Cl. 280/652

(57) ABSTRACT

A hand operated utility cart with an extended handle assembly capable of supporting extra long loads. The preferred embodiment includes a kick stand allowing for a free standing, horizontally level cart, a curved handle bar assembly with a threaded aperture allowing the load to remain in a horizontal position during operation and a locking hand brake system. The hand operated utility cart can be quickly broken down and reassembled to allow for easy transportation and storage. The cart may be provided with a basket. The cart may be provided with a hitch for attaching the cart to a vehicle. The height of the cart may be adjustable.

### CROSS-REFERENCE TO RELATED APPLICATIONS

This is a continuation-in part of the U.S. patent application Ser. No. 09/616,050 filed Jul. 13, 2000 which claims priority from U.S. Provisional Patent Application serial No. 60/154,829 filed Nov. 12, 1999 both of which are incorporated herein by reference in its entirety.

This relates to U.S. Disclosure Document Number 430471, filed Jan. 29, 1998 incorporated herein by reference in its entirety.

This also claims priority from U.S. Provisional Patent Application serial No. 60/328,707 filed Oct. 12, 2001 incorporated herein by reference in its entirety.

### BACKGROUND OF THE INVENTION

This invention relates to new and useful improvements of hand operated utility carts and more particularly to a process for transporting hunting game and equipment. It relates to hunting carts used in transporting game from the hunting site.

The use of carts is known in the prior art. Carts have been utilized for the purpose of transporting items. By way of example the prior art disclosed in the U.S. Pat. No. 5,673,928 to Jury a folding portable cart, U.S. Pat. No. 5,295,556 to Mullin a multipurpose hunting cart, U.S. Pat. No. 5,492,196 to Michno a portable deer cart and tree stand, U.S. Pat. No. 4,045,040 to Fails a deer stand and game carrier, U.S. Pat. No. 5,713,497 to Ponczek a deer carrier, Design Pat. No. 391,734 to Melgey a cart for transporting harvested deer and Design Pat No. 5,853,189 to Swartzlander a cart.

Prior hunting carts have had many disadvantages. One major difficulty is that other hunting carts are too low to the ground. This results in dragging the cart, hanging up on ground obstructions, and requires excess strength for pulling the cart. Additionally previous deer carts have had the main body of the cart built between the wheels of the cart. This inhibits the loading of the deer onto the cart. The deer must be loaded carefully between the wheels and frequently moved to avoid rubbing by the wheels. Another difficulty has been load stability.

Specifically Design Pat. No. 5,853,189 discloses a collapsible, two-tier cart with a ‘T’ bar handle assembly. In order to keep the load from obstructing the wheels, this patent had to incorporate a two level design. This has resulted in excess weight designed into the cart. The straight ‘T’ bar design of the handle assembly places the load at an angle when transporting in a hand operated mode. This design results in the main body of the cart being on an incline causing the load to be off balance and making it difficult to maneuver. This incline also makes it difficult to operator the cart in a push mode. In this design, the placement of the wheels on the outside of the main carrying deck results in the need for a wider cart to transport similar size loads.

Previous designs have had many flaws. The principle object of this invention is to provide a cart that provides easy maneuverability in both a pushing and pulling direction while maximizing load area and provides load stability through the use of an extended handle assembly.

### SUMMARY OF THE INVENTION

The primary object of the invention is to provide a machine that allows for weight and balance stability. A further object of the invention is to provide a machine with an extended handle assembly allowing for full walking stride without striking foot heels against cart. Other objectives of the invention are to provide a machine as narrow as possible for maneuverability without sacrificing stability, that reduces back strain potential, that allows comfort in pulling, that easily operates in a push or pull mode, that has clearance to overcome ground obstructions, that is quiet while being used, that assembles in minutes, that allows for easy loading/unloading, and that breaks down for storage and transportation purposes.

Another object of the invention is to allow for the load to be level during operation, allow for easy break down by one person, to allow for one or two man operation.

Other objects and advantages of the present invention will become apparent from the following descriptions, taken in connection with the accompanying drawings, wherein, by way of illustration and example, an embodiment of the present invention is disclosed.

In light of the above mentioned shortcomings of the known prior arts, the present invention was developed. The invention is a hand operated utility cart which includes an extended handle assembly capable of supporting extra long loads, a primary platform and a modified bicycle fork assembly.

The cart includes a single platform mounted on top of two independent front bicycle fork assemblies. An extended handle assembly includes a long rectangular member, a bicycle handle bar with stem, an extended kickstand and a hand lock breaking system secured to the platform.

For a better understanding of the invention, its operating advantages and specific objectives of its uses, reference should be made to the accompanying drawings along with its descriptive matter in which there is illustrated embodiments of the invention.

The drawings constitute a part of this specification and include exemplary embodiments to the invention, which may be embodied in various forms. It is to be understood that in some instances various aspects of the invention may be shown exaggerated or enlarged to facilitate an understanding of the invention.

Another embodiment of the present invention provides a modified stem and a canvas lined basket for the Multi-Purpose Deer Hunting Cart as described in U.S. patent application Ser. No. 09/616,050 entitled a Multi-Purpose Deer Hunting Cart.

In its entirety, the Multi-Purpose Deer Hunting Cart is a hand operated utility cart with an extended handle assembly capable of supporting extra long loads. The preferred embodiment includes a kick stand allowing for a free standing, horizontally level cart, a curved handle bar assembly with a threaded aperture allowing the load to remain in a horizontal position during operation and a locking hand brake system. The hand operated utility cart can be quickly broken down and reassembled to allow for easy transportation and storage.

The use of the modified stem is to eliminate parts, make the cart easier to break down and make the cart safer to operate.

If desired, the cart may further include additional parts to form a basket and may include a canvas, or other fabric, liner for this basket. The basket and liner could be helpful to carry items that fit in the basket. This new invention provides for a set of four rails (two longitudinal members and two transverse members) and four corner posts (vertical supports) that connect to the cart by removing plastic caps from each corner of the platform. Four expandable inserts, comprised of a bolt, two nuts and rubber between the nuts, are inserted into these corner posts. The transverse and/or longitudinal rails are attached to the corner posts with additional expandable inserts or the transverse and/or longitudinal rails are attached to the corner posts by having a square nut spot welded at their ends and a bolt passing through the corner post and screwed into the welded bolt. When these rails are assembled together they make a box or basket useful for hauling firewood, tools, etc. The canvas inlay is used to keep things dry and provides an enclosure so items will not fall out. Additionally a canvas cover provides protection from inclement weather.

The invention may also be provided with a trailer hitch. The trailer hitch is used by removing the handlebar assembly and replacing the handle bar assembly with the trailer hitch.

### BRIEF DESCRIPTION OF THE DRAWINGS

FIG. 1 is a perspective view of an embodiment of the present invention.

FIG. 2 is a plan front view of the embodiment of FIG. 1.

FIG. 3 is a plan rear view of the embodiment of FIG. 1.

FIG. 4 and FIG. 5 are plan side views of the embodiment of FIG. 1.

FIG. 6 is a plan top view of the embodiment of FIG. 1.

FIG. 7 is a plan bottom view of the embodiment of FIG. 1.

FIG. 8 is a schematic transverse cross-section of a platform of a second embodiment of the present invention.

FIG. 9 is a schematic longitudinal cross-section of the platform of the embodiment of FIG. 8.

FIG. 10 is a schematic transverse cross-section of a platform of a third embodiment of the present invention.

FIG. 11 is a schematic longitudinal cross-section of the platform of the embodiment of FIG. 8.

FIG. 12 shows an enlarged view of a portion of the kickstand of FIG. 5.

FIG. 13 shows a perspective view of a fourth embodiment of the cart of the present invention with a fabric, typically canvas liner.

FIG. 14 shows a canvas floor for use with the embodiment of FIG. 1 or 13 (if the basket is removed) and a bag for holding the floor.

FIG. 15 shows a perspective view of the cart of FIG. 13 without the fabric liner.

FIG. 16 shows the parts of the upper frame of the basket, fabric liner, fabric floor and bungee loops for use with the embodiment of FIG. 13 unassembled.

FIG. 17 shows a perspective view of the fabric liner of FIG. 13.

FIG. 18 shows a portion of the modified version of the fabric liner of FIG. 17.

FIG. 19 shows an expandable insert for use with the cart of FIG. 13.

FIG. 20 shows a cross section 20-20 of FIG. 19.

FIG. 21 shows an end view of a transverse member of the basket of FIG. 16.

FIG. 22 shows the cart of FIG. 13 with the basket frame and canvas liner separate from the cart.

FIG. 23 shows a detailed view of a handlebar and stem of the embodiment of FIG. 13.

FIG. 24 shows an exploded view of the handlebar and stem of FIG. 22.

FIG. 25 shows a top view of the stem of FIG. 22.

FIG. 26 shows a side view of the stem of FIG. 22.

FIG. 27 shows a rear view of the stem of FIG. 22.

FIG. 28 shows an exploded view of the stem of FIG. 22.

FIG. 29 shows an ATV hitch employed with a cart embodiment of FIG. 1.

FIG. 30 shows a view of the hitch of FIG. 29 alone.

FIG. 31 shows a fifth embodiment of the cart of the present invention.

FIG. 32 shows a telescoping kickstand in a retracted position.

FIG. 33 shows a portion of the kickstand of FIG. 30 held by a pin in a downwards position.

FIG. 34 shows a side view of the platform of the embodiment of FIG. 31 without a basket.

FIG. 35 shows a bottom view of the platform of the embodiment of FIG. 31 without a basket.

FIG. 36 shows a bottom view of the platform of the embodiment of FIG. 31 with a basket.

FIG. 37 shows a rear view of the platform and basket of the embodiment of FIG. 31.

FIG. 38 shows a side view of the platform and basket of the embodiment of FIG. 31.

FIG. 39 shows a top view of the side gate of the basket if the embodiment of FIG. 31.

FIG. 40 shows a side view of the side gate of the basket of the embodiment of FIG. 30.

FIG. 41 shows a front view of a front gate of the basket of the embodiment of FIG. 31. (the front gate and back gate are typically of the same construction)

FIG. 42 shows a side view of the front gate of the basket of the embodiment of FIG. 31.

FIG. 43 shows a perspective view of an open rear gate.

FIG. 44 shows a perspective view of the rear gate of FIG. 43 in a closed position.

FIG. 45 shows a side view of a fork assembly of the embodiment of FIG. 31.

FIG. 46 shows a front view of a fork assembly of the embodiment of FIG. 31.

FIG. 47 shows a perspective view of a portion of the embodiment of FIG. 31.

FIG. 48 shows a portion of the bicycle stem assembly of the embodiment of FIG. 31.

FIG. 49 shows an ATV hitch for the embodiment of FIG. 31.

FIG. 50 shows a top view of a canvas liner for the embodiment of FIG. 31.

FIG. 51 shows a right side view of the canvas liner of FIG. 50 for use with the cart of FIG. 31.

FIG. 52 shows a left side view of the canvas liner of FIG. 50 for use with the cart of FIG. 31.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

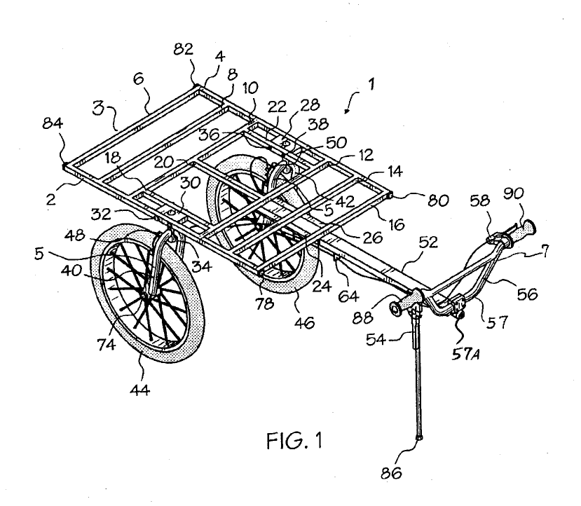

Turning first to FIG. 1 in which like reference numbers indicate like elements, there is shown an exploded view of a cart I of the present invention. The cart includes a single platform 3, two independent front bicycle fork assemblies 5 and an extended handle assembly 7.

The platform 3 is typically about 1 to about 2½ feet above the ground, preferably about 1½ to about 2 feet above the ground. The platform width is typically about 20 to 36 inches and its length is about 2 to about 5 feet preferably about 30 to about 52 inches.

The platform 3 includes two ¾ inch box tubes which are 36 inches long 2,4, six ¾ inch box tubes which are 24 inches long 6,8,10,12,14,16 and three ¾ inch box tubes which are 12 inches long 18,20,22. These items are joined by a rigid immobile relationship by welding. Overall dimensions of the platform 3 are 25½ inches by 36 inches but are not limited to this size. Two holes are drilled through each member 2,4 1⅜ inches from each side of center and two holes are also drilled through members 18 and 22 about 1⅜ inches from each side of center. Two 1 inch by 1 inch angle irons which are 12 inches long 24,26 are also welded to the bottom side of the main platform members 12, 14 and 16 about 1 inch on each side of center.

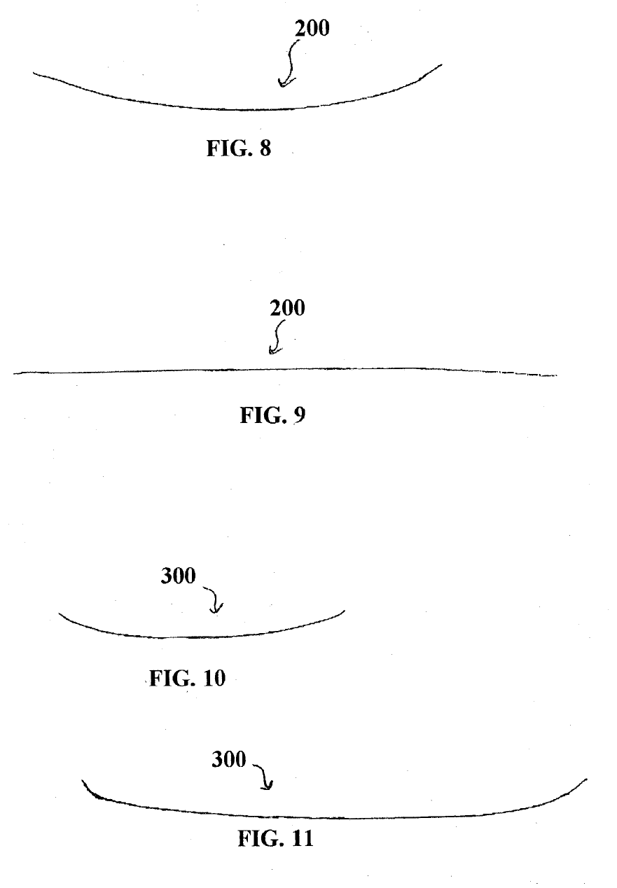

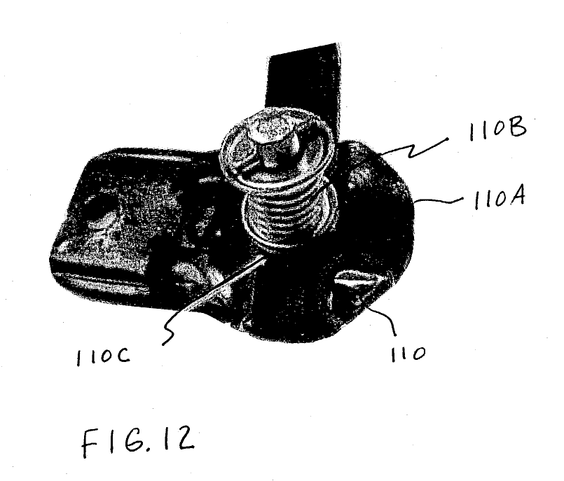

The platform 3 is shown as having a flat planar upper surface and a flat planer lower surface. However, in a second embodiment 200, the bars can be curved to form an upper surface having a concave cross-section in the transverse direction (FIG. 8) and a straight cross-section in the longitudinal direction (FIG. 9). In a third embodiment 300, the bars can be curved to form an upper surface having a concave cross section in both the transverse direction (FIG. 10) and longitudinal direction (FIG. 11). If desired the bars can be curved to form an upper surface having a straight cross-section in the transverse direction and concave cross-section in the longitudinal direction (not shown).

In accordance with the present invention, FIG. 1 shows two bicycle fork assemblies 5 secured with members 32,34,36,38, which are typically 4 inch carriage bolts secured to the main platform 3. Each fork assembly 5 is secured by two of the carriage bolts 32, 34, 36, 38. Removal of any one of the two carriage bolts 32, 34, 36, 38 for the respective fork assembly 5 forms a hinge. Each individual fork assembly 5 includes fork mounts 28, 30 and bicycle forks, 40, 42. The bicycle fork assemblies 5 can be removed by removing the carriage bolts 32, 34, 36, 38. If desired, the bicycle fork assemblies 5 can be pivoted by removing one bolt of each pair of bolts 32, 34 or 36, 38. The fork mounts 28,30 are 3¼ inches by 2 inches by ⅝ inch flat stock steel with a 1 inch hole through its center and two ¼ inch holes through its sides which are perpendicular to the 1 inch center hole and each about 1⅜ inches from center. The distance between each fork mount 28,30, and a respective bolt securing a brake to the fork assembly 5 is typically a minimum of 2½ inches. This will insure for proper clearance of the brake cable. The fork mount 28,30 is joined to the bicycle forks 40,42 by a rigid immobile relationship by welding. Bicycle forks 40,42 are 20 inch front bicycle forks but are not restricted to that size.

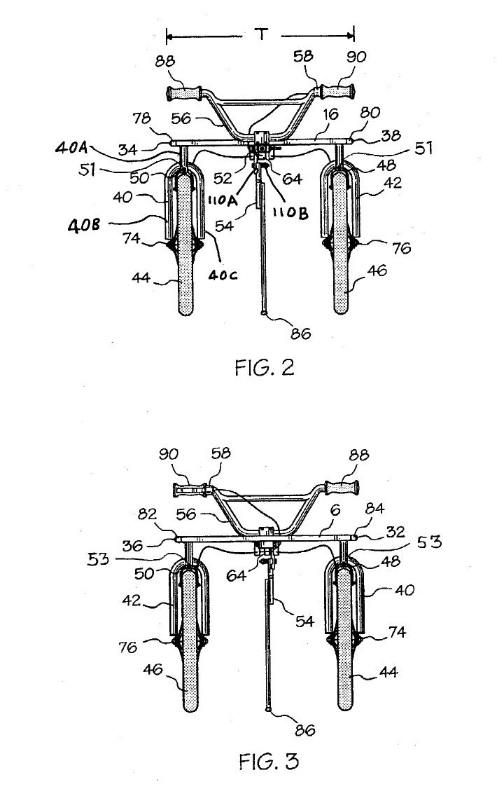

Each bicycle fork 40, 42 has a stem 40A (FIG. 2), a first prong 40B and a second prong 40C. Each bicycle fork 40, 42 has a first end and a fork 40, 42 second end. The stem 40A has a stem first end and a stem second end. The stem first end is joined to the respective bicycle fork mount 28, 30. The stem 40A extends downwardly from the respective bicycle fork mount 28, 30 to the stem second end. The first prong 40B and the second prong 40C both extend downwardly from the stem second end to the fork 40, 42 second end where the two prongs of the respective fork are releasably attached to opposed sides of the respective wheel.

The wheel supports shown by FIG. 1 are U-shaped forks, and there are no elements of the cart between the wheel supports in a space of from ground level to a height of at least about 50% of the height of the platform lower plane above the ground level. Preferably, there are no elements of the cart between the wheel supports in a space of from ground level to a height of at least about 75% of the height of the platform lower plane above the ground level

In accordance with an important feature of the present invention, there is shown in FIG. 1, wheels 44,46 which are 20 inch wheels secured to the forks using a quick release skewer 74,76. The wheel size is based upon the fork size used in the present invention.

To accomplish an important function of the invention, there is shown in FIG. 1, members 48,50 which are each an ATB Caliper Brake Set secured to each fork assembly 5 by means of a 2¾ inch bolt 51 (FIG. 2) having a ¼ 20 thread and a ¼ 20 nut 53 (FIG. 3).

FIG. 1 also shows removable plastic end caps 78, 80, 82, 84. The end caps 78, 80, 82, 84 are removable to expose openings so that, if desired, vertical posts (such as those shown for the fourth embodiment of FIG. 13) for an upper basket assembly can be attached by bolts or other suitable means to the platform 3.

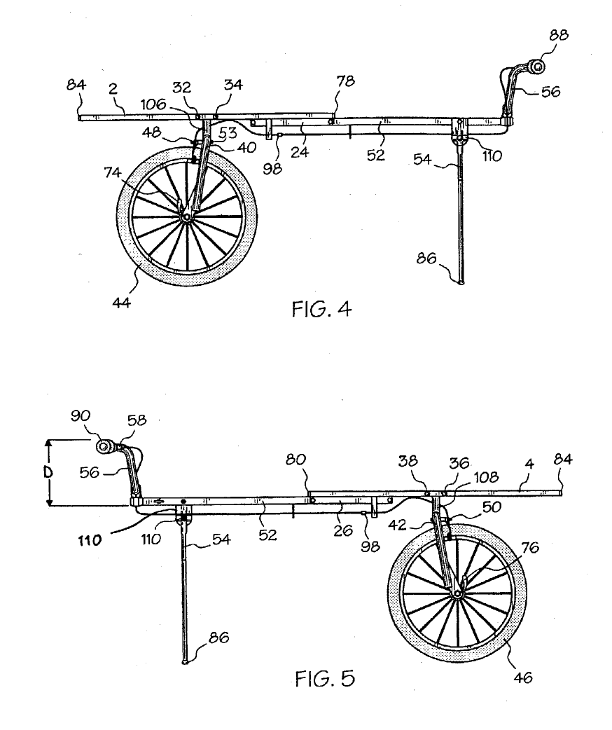

As shown in FIGS. 4 and 5, the longitudinal handle 52 and the platform 3 are entirely parallel. Moreover, the wheels 44, 46 are below a plane upon which the bottom side of the platform 3 lies.

Turning to FIG. 7 brake cable steady mounts 60,62 each with a threaded hole, are permanently welded to members 24 and 26 at approximately a 30 degree angle about 10 inches from the front bar 16 of the platform 3. A brake cable 100 extends from one brake set 48 (FIG. 1) through the two steady mounts, 60,62, to a second brake set 50 (FIG. 1). Secured to the brake cable 100 between the steady mounts 60,62 is a yoke hanger mount 98. A second brake cable 102, which is secured to a yoke hanger mount 98 at the side nearest the platform 3, runs through a third steady mount 64 and is then attached to a locking hand brake 58. The locking hand brake 58 is attached to the transverse handle bar system assembly 56. The platform 3 also has end caps 78, 80, 82 and 84 (FIG. 1).

In accordance with an important feature of this embodiment of the present invention, there is shown in FIG. 7 the extended handle bar assembly 7. The primary piece is a 2 inch by 1 inch by 36 inch longitudinally arranged steel box tubing 52. Two 5/16-inch holes, which go entirely transversely through longitudinal tubing 52 and angle iron members 24, 26, are located about ½ inch and about 11½ inches from the front base 16 of the platform 3 and are for securing the assembly to the angle iron members 24,26 (FIGS. 4, 5, 6). A third hole which is about ⅜ inches in diameter, goes through steel box tubing 52 and is located about 6 inches from the transverse handle bar stem assembly 56. This third hole is used to secure the kickstand 54 to the extended handle bar assembly 7 by means of a 2½-inch bolt, having a ⅜ inch 16 thread, and a ⅜ inch 16 nut. A smaller secondary screw is threaded through the kickstand mount into main tubing 52 and is used to eliminate twisting and turning of the kickstand. A final 5/16 inch hole is drilled into tubing 52, and member 96 (FIG. 7), a 1 inch by 6 inch steel tube, which has been welded into the inner diameter of longitudinal tubing 52. A ¼ inch 20-flange nut 94 is welded to tubing 52 with its center lining up with that of the final 5/16-inch hole as described above. A 1 inch long ¼ inch 20 threaded eye bolt 92 is then screwed into the flange nut 94 located on tubing 52. Eyebolt 92 penetrates through nut 94, tubing 52 and tube 96 and finally the stem of the bicycle handle bar assembly 56. This helps to prevent the possible twisting of the bicycle handlebar assembly 56. Eyebolt 92 can also be used to fasten a load that extends beyond the front of the platform to the bicycle handlebar assembly 56.

Typically, the tubing 52 extends 2 to 3½ feet from the platform 3 and the transverse handlebar assembly 56 has a U-shaped portion 57 and handle portions extending from the U-shaped portion having handles 88,90 and the locking hand brake 58 mounted on one of the handle portions, and the stem 57A provided with four screws for securing the U-shaped portion 57 (FIG. 1). Also typically the transverse handle bar stem assembly 56 extends a distance “D” of about 5 to about 12, preferably about 6 to about 8 inches, above the longitudinal axis of the longitudinal tubing 52 (see FIG. 5). Handlebar assembly 56 has a width “T” typically about 12 to about 30 inches.

Still in FIG. 7 there is a 1 inch by 2 inch by ⅛ inch flat stock steel plate, member 104, with a 1 inch hole drilled though the center that is welded to the end of handle tubing 52 at the end nearest the handle bar assembly 56. The stem of the bicycle handlebar assembly 56 slides through the hole of member 104 and into the 1 inch steel tubing 96. The bicycle handlebar assembly 56 may be secured to tubing 96 within handle tubing 52 with an expander bolt and wedge or other suitable means.

Turning now to FIG. 5, the final piece shows a welded stop for single direction operation, namely, a small piece of round stock member 110 ½ inch length ¼ inch diameter, welded to the kick stand mount to prevent the kick stand from going past perpendicular when in use.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

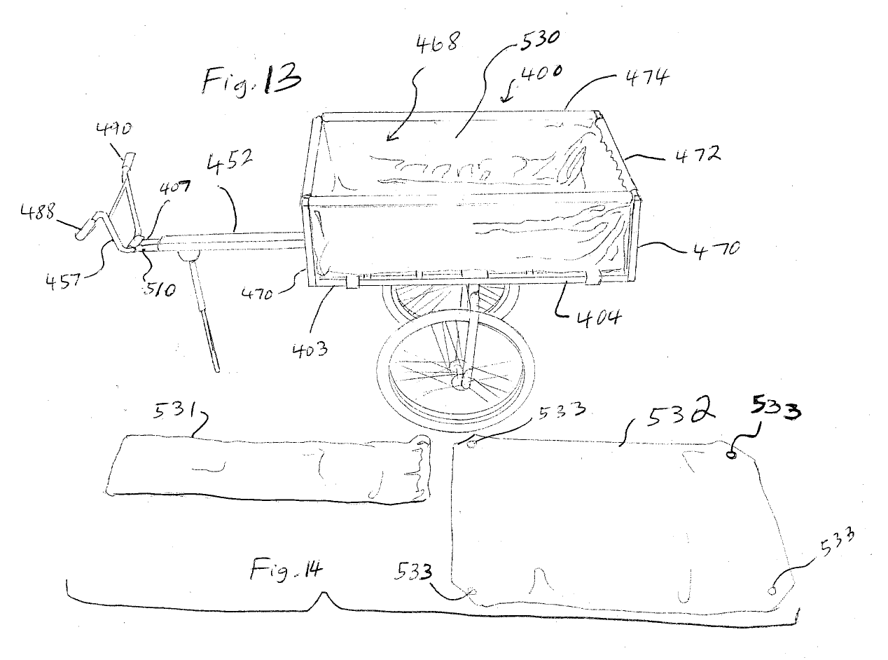

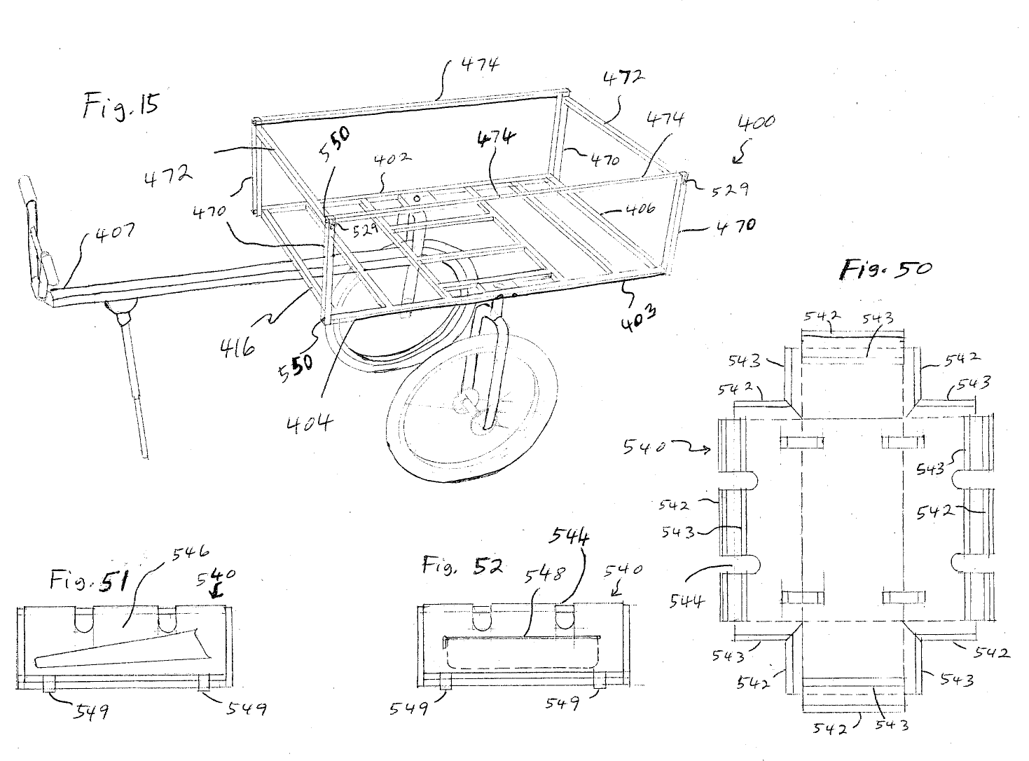

If desired, the kickstand may comprise a modified flattened bracket 110A (FIG. 5); the welded stop 110 for single directional operation; a spring 110B; and a washer 110C slipped between the spring 110B and the bracket 110A for added tension (FIG. 12).

FIG. 13 shows a fourth embodiment of the cart 400 of the present invention. It is substantially the same as the first embodiment but its handle assembly 407 has a different transverse bicycle handlebar stem assembly 510 and it has a removable basket 468. The use of the modified stem is to eliminate parts, make the cart easier to break down and make the cart safer to operate. The parts this invention will eliminate are members 104, the 1 inch steel tubing, member 96 as shown in FIG. 7, and the bicycle stem member 56 shown in FIG. 2. The round tubular stem has been changed to a solid rectangular stem as shown in FIG. 21. This modified stem provides simplicity and safety.

The transverse bicycle handlebar stem assembly 510 includes a U-shaped portion 457 having opposed handles 488, 490 and a locking hand brake (not shown) as in the first embodiment. However, the tube member 96 of the first embodiment is replaced by a stem 513 described in more detail below. The stem 513 has a generally rectangular cross-section. If desired, the stem 513 may be hollow or solid and may have grooves 518.

The cart 400 is provided with an optional removable basket 468 which includes four vertical supports 470, two transverse cross-members 472 and two longitudinal members 474. Typically, the vertical supports 470 are nominally one foot long, the transverse upper cross members 472 are nominally two feet long, and the longitudinal members 474 are nominally three feet long.

The vertical supports 470 are attached to the platform 403 of the cart 400 by passing expansion bolts 550 (FIG. 15) through transverse holes, at the lower end of each vertical support 470, longitudinally into open ends of the longitudinal members 404 and then tightening the bolts 550. FIG. 19 shows an expansion bolt in detail. Likewise, the upper longitudinal members 474 and the vertical supports 470 are attached by passing expansion bolts 536 through a first pair of aligned holes adjacent the upper end of each vertical support 470 longitudinally into open ends of the upper longitudinal members 474.

If desired, upper transverse members (rails) 472 may be removed while keeping vertical supports 470 upright and attached to the upper longitudinal members 474. This provides a basket having side gates with an open front and open rear so the load may protrude from the front and rear of the basket.

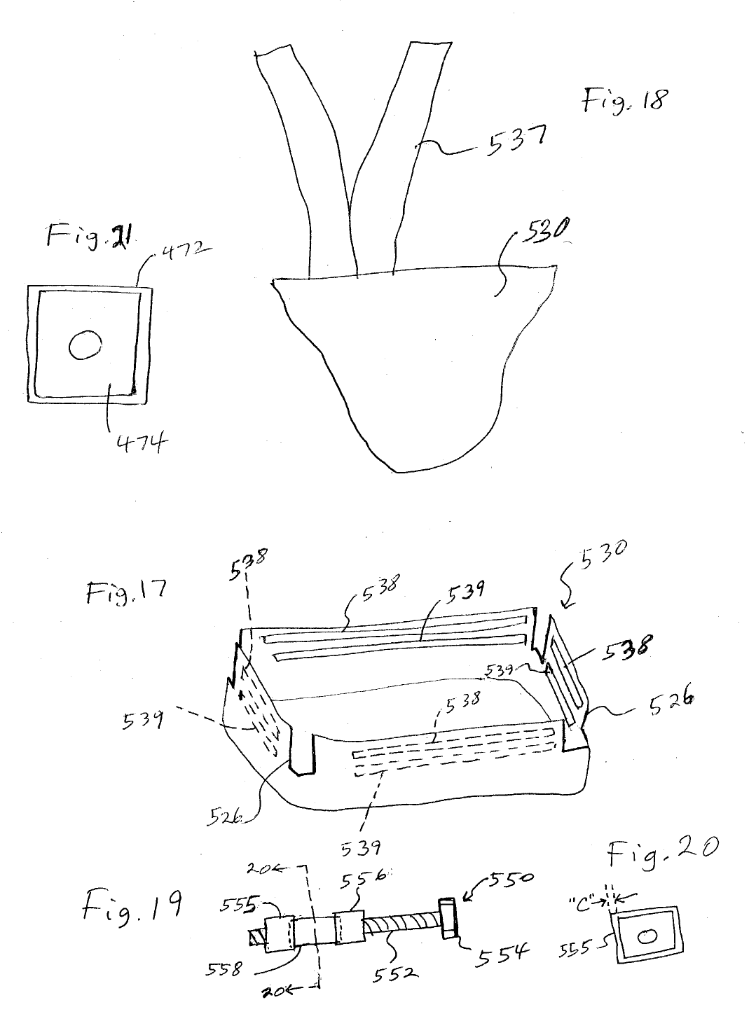

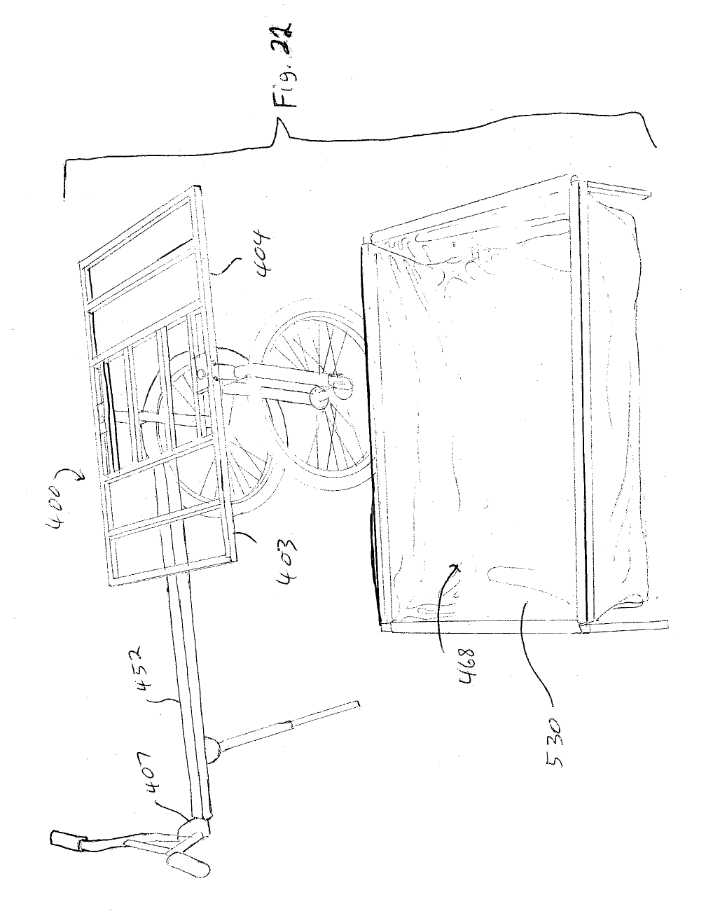

The upper transverse members 472 and vertical supports 470 are attached by having a nut, typically a square nut 474 (FIG. 20), fixed (by welding or other means) in the opposed open ends of the upper transverse cross member 472. The upper end of each vertical support 470 has a second pair of aligned holes located in the outer walls between the outer walls having the first pair of aligned holes. The second pair of aligned holes are sufficiently lower than the first pair of aligned holes that a bolt 529 is passed through the second pair of aligned holes and threaded into the welded nut 474 in the respective open end of the transverse cross member 472 to attach the transverse cross member 472 to the vertical support 470.

The basket 468 is optional and adds weight and complexity to the cart 400, but it is useful for carrying items which fit into the basket 468 and could possibly roll out. When the basket is not employed, removable end caps, such as end caps 78, 80, 82, 84 of FIG. 1 may be employed to close the openings at each corner of the platform 403.

If desired a fabric, for example canvas, liner 530 may be employed to line the basket 468 as shown in FIG. 13.

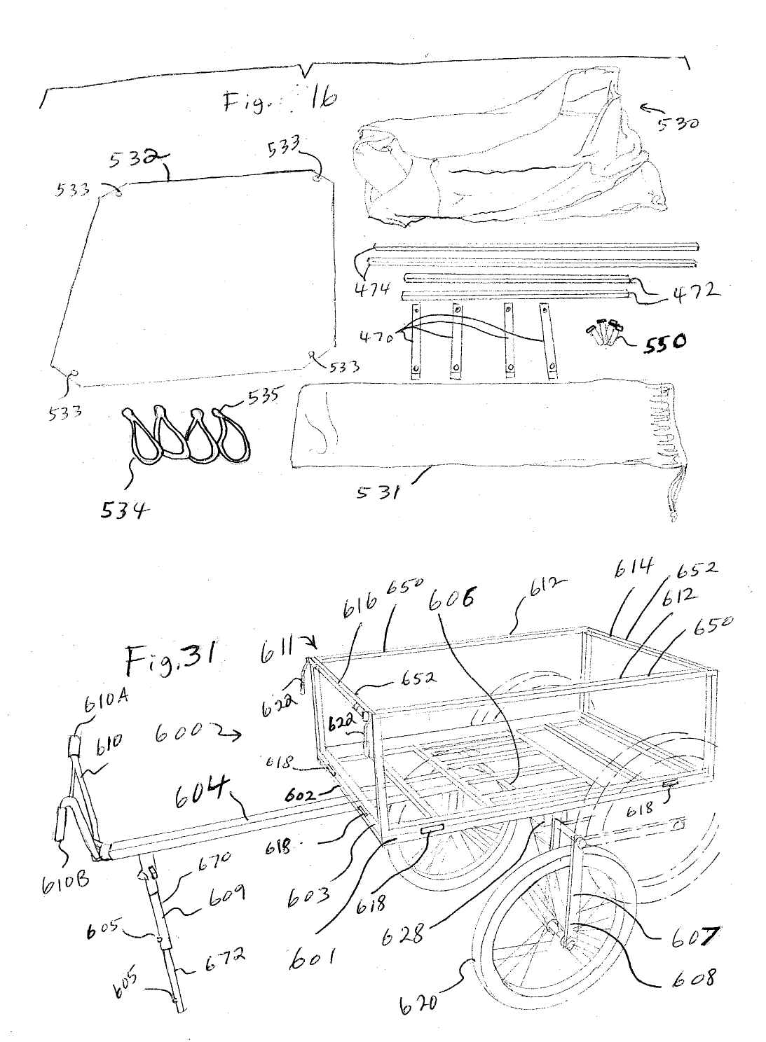

FIG. 16 shows parts of the basket 468 disassembled as well as a fabric liner 530, bag 531, fabric floor 532, bungee loops 534 and expandable inserts 550. The disassembled basket parts include vertical supports 470, transverse cross-members 472 and longitudinal members 474. When disassembled, these parts conveniently fit into the bag 531.

The fabric liner 530 typically has cutouts 526 and may be attached to the basket frame by any suitable means. For example, the perimeter about the inner side walls of the fabric liner 530 may be provided with mating hook fastener strips 538 and loop fastener strips 539 (typically VELCRO strips) as shown in FIG. 17. Each side of the outer perimeter of the liner 530 folds over a respective longitudinal member 472 or transverse cross-member 474 so that each hook fastener strip 538 mates with a respective loop fastener strip 539. Of course the locations of strips 539 can be switched and/or the strips 538, 539 could be located about the perimeter on outer side walls of the liner 530. Optionally the fabric liner has slits (not shown) at its corners and the slits are lined with strips of mating hook and loop fasteners (not shown), such as strips of VELCRO hook and loop fastener material, this aspect is also shown for the embodiment of FIG. 50.

Alternatively, straps 537 may be provided at the liner 530 perimeter instead of the strips as shown in FIG. 18. The straps 537 would extend from the liner 530 and could be tied about a respective longitudinal member 472 of transverse cross-member 474.

The fabric floor 532 and bungee loops 534 are used together. The bungee loops 534 are inserted through grommet holes 533 at the corners of the fabric floor 532 such that its thick end 535 is held against the grommets and each loop of bungee cord 534 inserted through a respective grommet hole 533 is looped over a respective corner of the platform 403 to hold the fabric floor 532 in place on the platform 403. The fabric floor 532 is useful to keep objects from dropping through the platform 403. The fabric floor 532 is applied without the basket 468 being employed.

FIG. 19 shows the expandable insert 550 for use to attach the vertical supports 470 to the platform 403 and/or attach the vertical supports 470 to the longitudinal members 474. The expandable insert 550 includes a threaded stem 552, a hexagonal head 554, square nuts 555, 556 and a square rubber washer 558. Square nut 555 has threads, while square nut 556 has no threads (smooth inner walls). Typically, opposed portions of the square nuts 555, 556 define respective hollows such that opposed sides of the rubber washer 558 are inserted into the square nuts 555, 556. The rubber washer 558 may in addition, or in the alternative be glued to the square nuts 555, 556.

In one method to make the expandable insert, a piece of rubber was placed on the threaded bolt stem 552 between the nuts 555, 556 and screwed down the threaded nut 555 until the unthreaded nut 556 was forced against the head 554 to put pressure on the rubber to squeeze the rubber out slightly. Then the rubber washer 558 was ground on a belt sander to have the same size perimeter as the nuts 555, 556. Then when the nut was loosened the tension on the rubber washer 558 was removed such that the rubber contracted sufficiently to fit in the opposed cavities (hollows) of the nuts 555, 556. Of course, other nut and rubber perimeter shapes having at least two, preferably at least four flat surfaces could be used in place of the square perimeters.

FIG. 20 shows a view of the cross-section 20-20 of the expandable insert 550 of FIG. 19. As seen in FIG. 20, the exposed perimeter of the rubber insert 558 at rest may be inset from the perimeter of the threaded nut 555 by a distance “C” of about 0 to about 1/64 inch, preferably at most 1/32 inch, more preferably at most 1/64 inch, typically about 10/1000 inch to about 1/64 inch. The threaded nut 555 has the same size perimeter as unthreaded nut 556. The nuts 555, 556 are sufficiently large and have at least two opposed flat sides to prevent significant turning within the square box tubing into which the expandable insert 550 is inserted. In use, as the head 554 of the expandable insert 550 is tightened, the nuts 555, 556 held by the box tubing to not significantly turn, squeeze the rubber washer 558, along the longitudinal axis of the expandable insert 550, to expand the rubber washer 558 laterally to firmly contact the inner walls of the box tubing to hold the expandable insert 550 in place in the box tubing. The rubber washer 558 is typically made of a suitably hard natural or synthetic rubber which will compress between the nuts 555, 556 but expand laterally when the nuts 555, 556 exert sufficient force on the rubber washer 558 to firmly engage the inner walls of the rubber tubing. A typical suitable rubber is AB-255, a NBR/SBR/CR (butadiene-acrylonitrite/styrene butadiene/polychloroprene) rubber, available from American Biltrite, Inc., Wellesley Hills, Mass. 02481. AB-255 rubber has a typical Shore “A” Durometer hardness of 60.

FIG. 21 shows an end view of the transverse member 472 to show the welded nut 474.

FIG. 22 shows a view of the cart having the platform 403 and the basket 468 is separate.

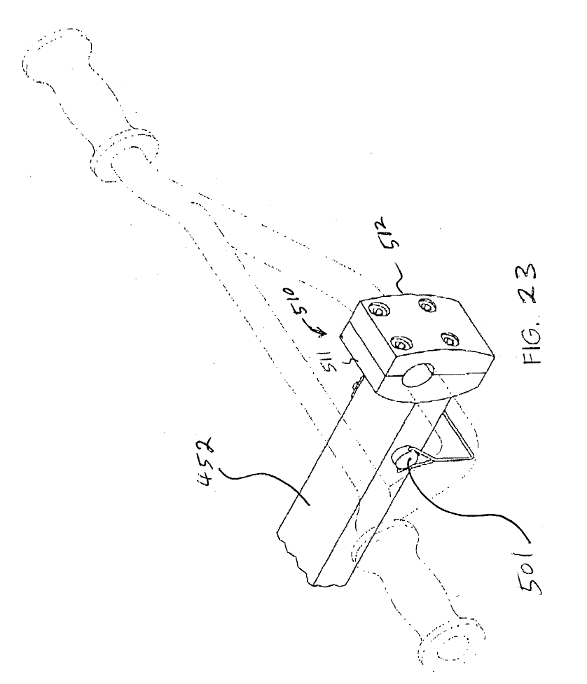

FIG. 23 shows a detailed view of a handlebar (in phantom) and stem assembly 510 of the embodiment of FIG. 13. The stem assembly 510 comprises a stem 513 (FIG. 23), a back handlebar holding member 511, and a front handlebar holding member 512. The stem 513 is a solid block of metal but has a transverse passageway 515 passing therethrough. The front handlebar holding member 512 is attached to the back handlebar holding member 511 by screws 514 which pass through openings 520 and screw into threaded openings 522 to firmly hold the handlebar (shown in phantom in FIG. 23) in place within opposed grooves 516, 518. The screws 517 may be loosened when it is desired to adjust the height of the handlebar.

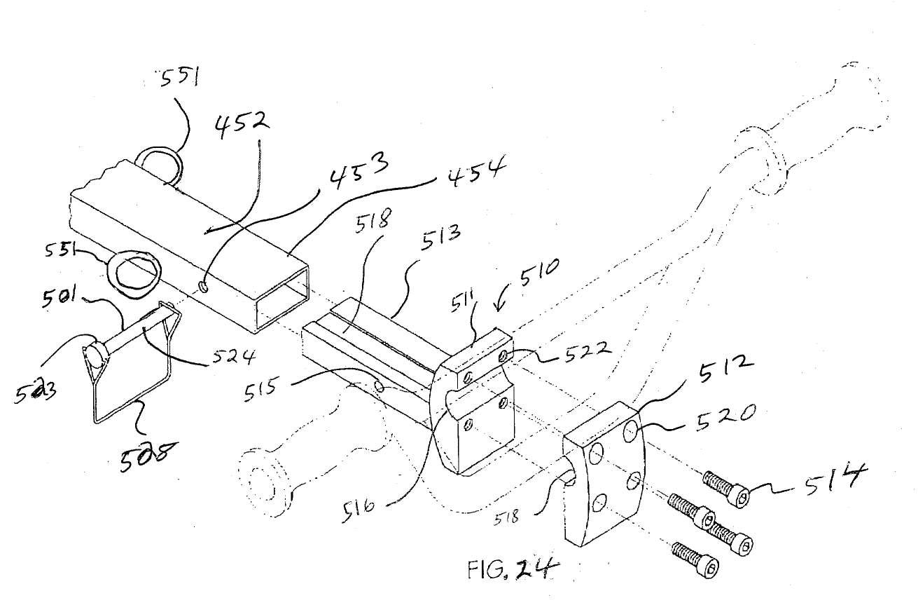

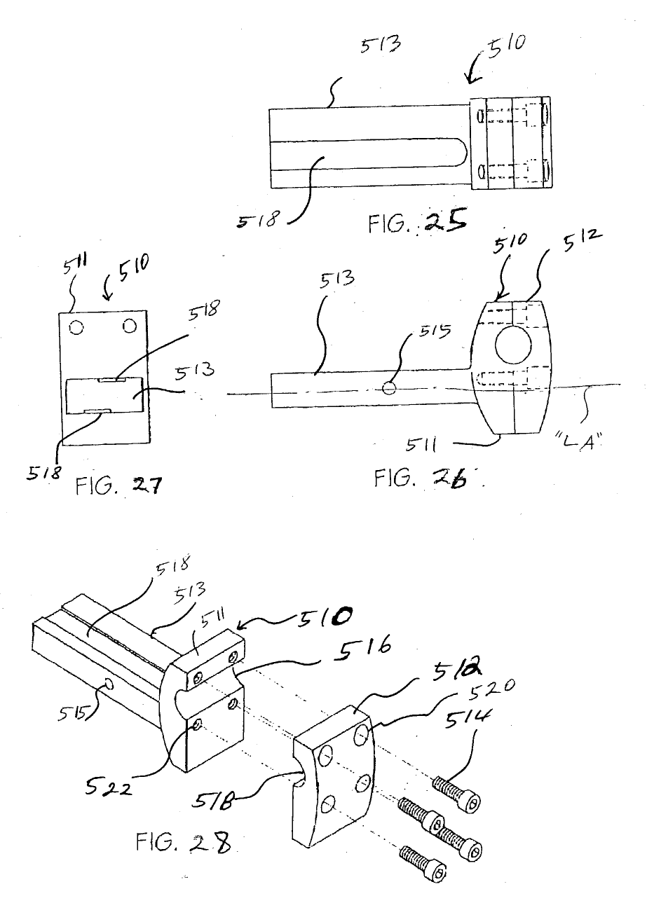

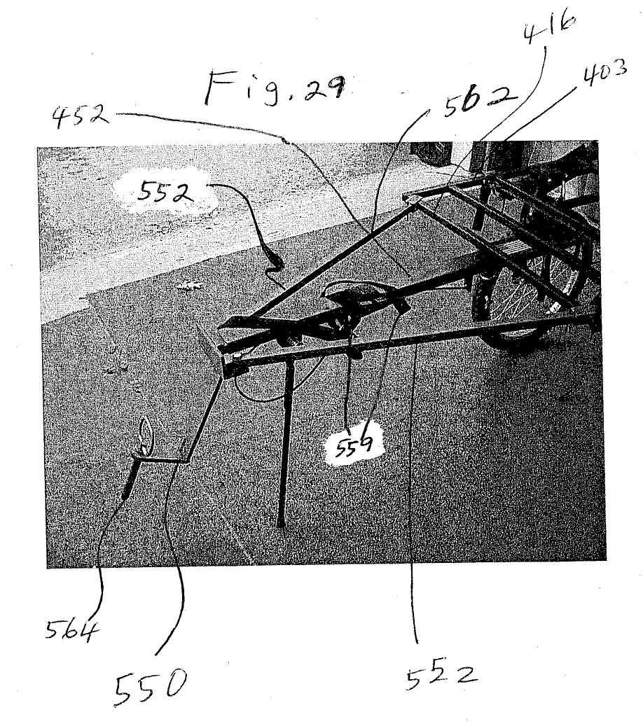

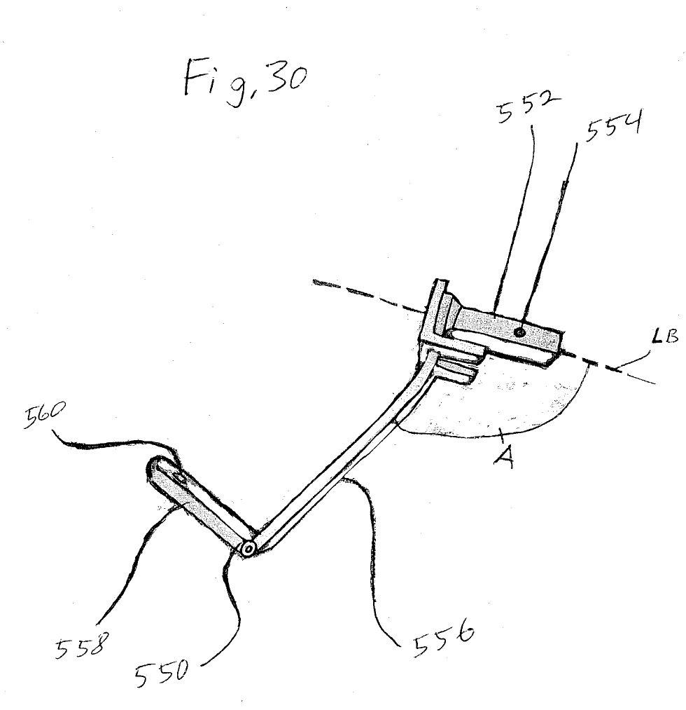

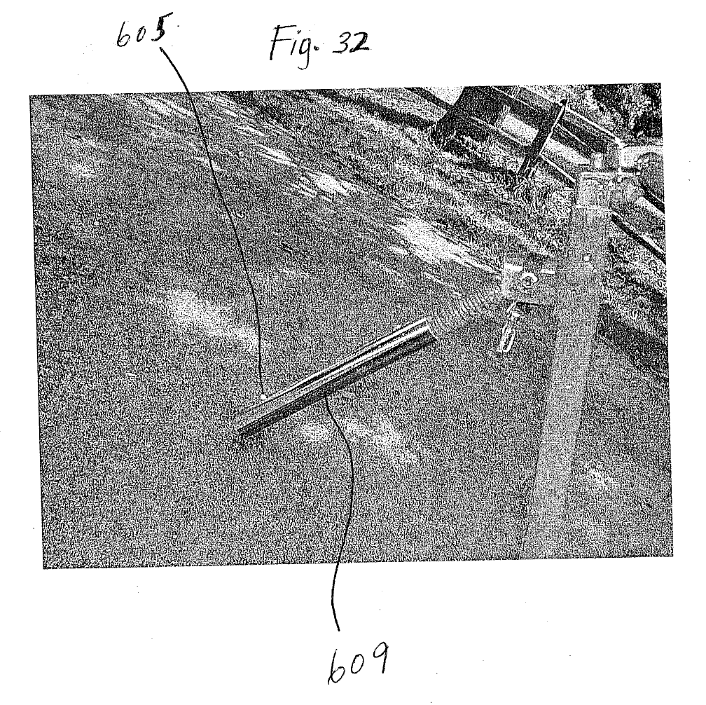

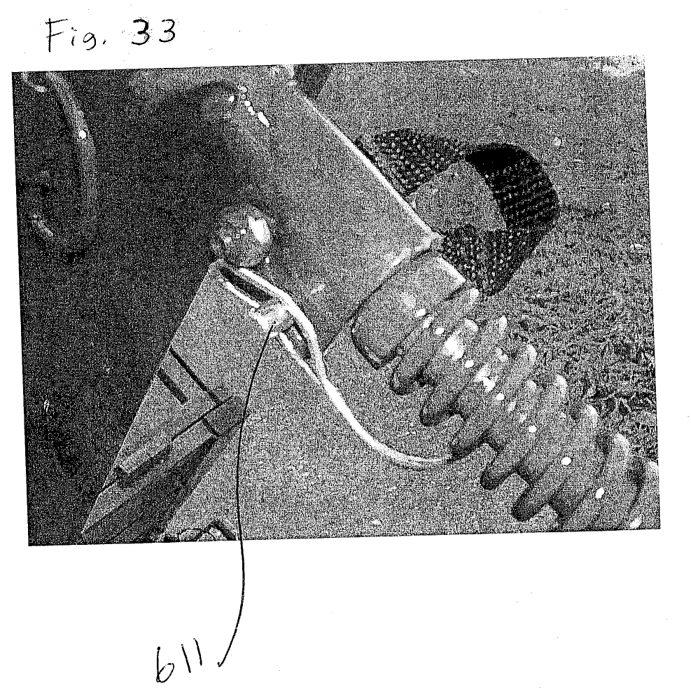

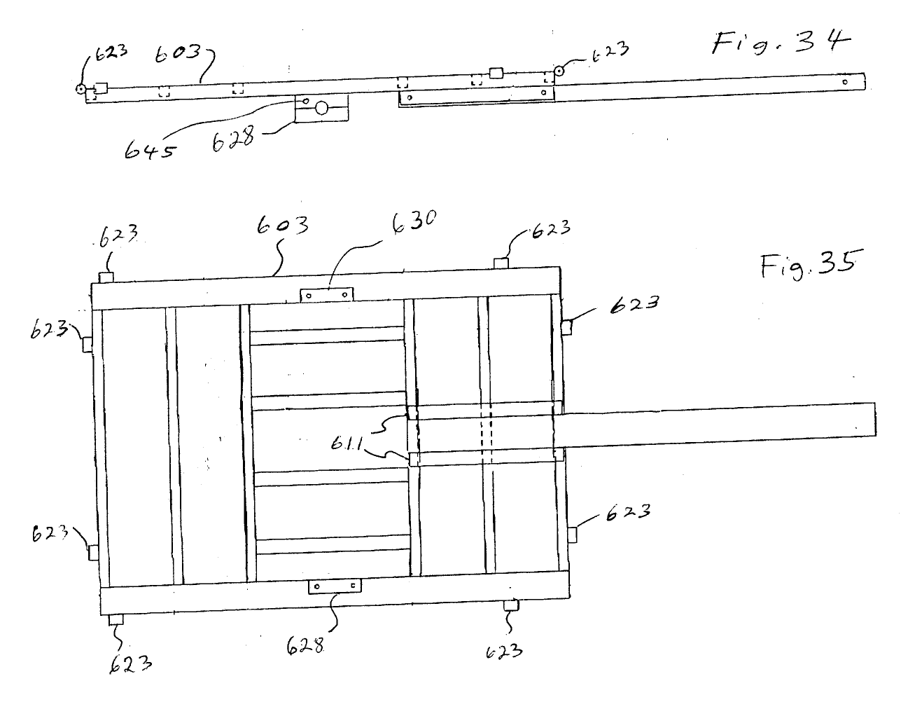

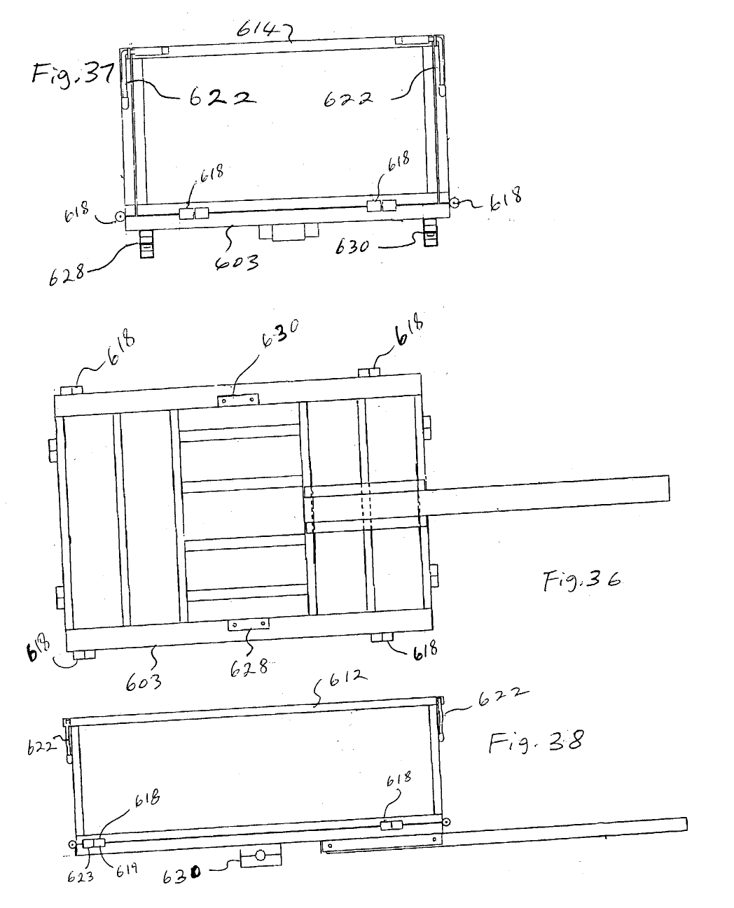

As shown by FIGS. 23 and 24, the stem 513 is pushed into the distal end 454 of the longitudinal handle 452 and then a pin 501, having a head 523 and pin stem 524 is pushed into a hole 453 of the longitudinal handle 452, through the transverse passageway 515 of the stem 513 and out another hole (not shown) on a sidewall of the longitudinal handle 452 opposed to the sidewall defining hole 453. The pin 501 has a U-shaped spring 528. One end of the spring 528 is attached to the head 523 and an opposed end of the spring 528 is located about the end of the pin 501 opposed to the head 523 to hold the pin 501 in place. FIGS. 25-28 show additional views of the stem assembly 510. The grooves 518 are useful to provide clearance between the stem 513 and a ridge (not shown) commonly in box tubing. FIG. 26 labels a longitudinal axis “LA” of the stem 513.

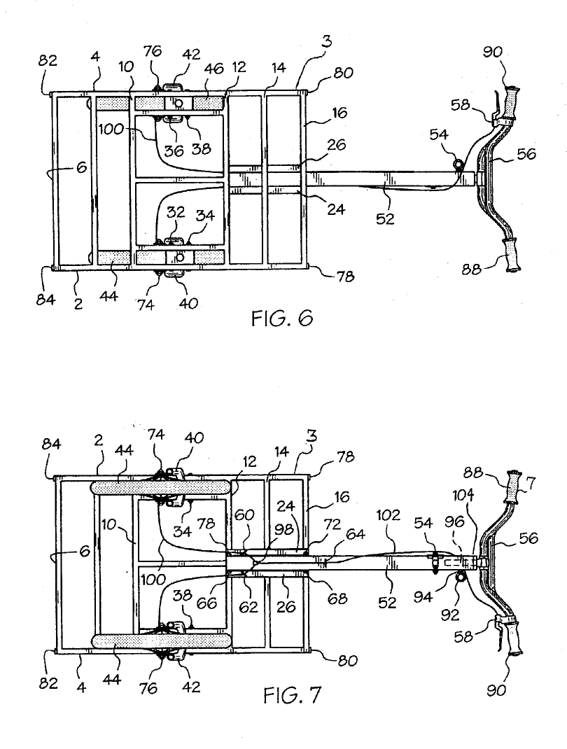

FIG. 29 shows the embodiment of the cart of the present invention of FIG. 1 provided with a removable hitch 550 for attaching the cart to an all terrain vehicle (ATV). If desired they may have straps 559 attached to the eyelets or other shapes, such as the circles 551 welded to the elongated handle 452 of FIG. 24, for holding items. e.g., a cooler, or a deer's head. If desired, the welded circles may be replaced by eyelet bolts screwed into nuts welded to the sides of the elongated handle, for example eyelet bolts 54 of FIG. 6.

FIG. 30 shows the structure of the hitch 550. As seen is in FIG. 30, the hitch 550 has a stem of 552 having a transverse passageway 554, and a downwardly extending extension 556 attached to or integral with a tongue 558. The tongue 558 has a hole 560 for passing a pin 564 (FIG. 29) therethrough to attach the hitch 550 to an ATV (not shown). The hitch 550 is attached to the distal end 454 of the longitudinal handle 452 as is the stem 513 of the stem assembly 510 described above. Namely, the stem 552 of the hitch 550 is inserted into the distal end 454 of the longitudinal handle 452 and held in place by the pin 501 passing through hole 453 of handle 452 and passageway 554. If desired other suitable means may be substituted for the pin 501, for example, a carriage bolt with a nut, or a bolt held by a cotter pin.

The hitch 550 may further be attached to the platform 403 with the braces 562. One end of the brace 562 is attached to the hitch 550 and the other end of the brace 562 is attached to the platform 403, typically to a front transverse member 416.

Also described below for another embodiment is an alternative stem which may be employed with the present hitch. If desired an additional tongue (not shown) may be attached to or integral with the extension 556 to be parallel with tongue 558. The additional tongue would also have a hole aligned with hole 560 such that pin 556 could pass through both holes.

FIG. 31 shows a fifth embodiment of the cart 600 of the present invention. The cart 600 has a platform 603 having longitudinal members 601 and transverse members 602, a longitudinal handle 604 attached to the platform, a fork assembly 607, comprising forks 608 attached to a rotatable rod 606, a telescoping kickstand 609 pivotably attached to the longitudinal handle 604, a bicycle handle assembly 610 attached to the longitudinal handle 604, and wheels 620, respectively attached to the forks 608. The longitudinal handle 604 is parallel to the platform 603. The transverse handle 610 locates its opposed handles 610A, 610B at a height higher than the height of the longitudinal handle 604. Typically, the handles 610A, 610B are about 5 to about 20 inches, for example about 5 to about 12 inches, higher than the longitudinal handle 604.

The rod 606 is rotatably mounted to mounts 628, 630 which are attached to of integral with the platform 603. The rod 606 is mounted to be rotatable about the rod's longitudinal axis between a “cart-up” position shown in FIG. 31 and a “cart-down” position shown in phantom in FIG. 31. As shown in FIG. 31, the rod 606 extends sufficiently transversely of the platform 603 that the forks 608 extend lateral of the platform 603, so the rod may rotate to move the wheels between the “cart-up” and “cart-down” positions with the wheels outside the perimeter of the platform 603. As shown in FIG. 31, in the “cart-up” position the wheels, while not directly under the platform 603, are below the plane upon which the bottom side of the platform 603 lies. If desired, the cart may have openings in the platform (not shown) to permit the wheels 620 to be directly under the platform yet still rotate between the “cartup” and “cart-down” positions.

FIG. 32 shows telescoping kickstand 609 in a retracted position. The kickstand has a hollow upper cylinder 670 having a hole in a lower section of its sidewall. A retracted extension 672 having lower and upper spring loaded protrusions is within the upper cylinder 670. To cause the kickstand 609 to telescope from the retracted position the spring loaded lower protrusion 605 is pushed in, the kickstand extension 672 slides out and the upper protrusion 605 locks into the hole formerly occupied by lower protrusion 605. A pin 611 may be used to lock the kickstand 609 in place (FIG. 33).

The “cart-up” position is useful when pulling the cart 600 by hand, especially over terrain where high ground clearance is advantageous. The “cart-down” position is especially useful when pulling the cart 600 behind an all terrain vehicle (not shown). FIGS. 34-42 show assorted views of various parts of the cart 600.

Cart 600 employs a removable basket 611 comprising side gates 612, a back gate 614 and a front gate 616 pivotally attached to the platform 603, typically by hinges 618. The front gate 616 is attached to the side gates 612 by latches provided with handles 622. For each gate, the various horizontal and vertical rails may be attached by any suitable means, for example welding.

Likewise, the back gate of 614 also has latches with handles 622 (FIG. 37) for attaching the back gate 614 to the side gates 612.

FIG. 34 shows a side view of the platform 603 and FIG. 35 shows a bottom view of the platform 603 without the gates 612, 614, 616. FIG. 35 also shows plastic caps 611 at the end of respective platform frame members.

FIGS. 36, 37 and 38 show bottom, rear and side views of the platform 603 with the gates 612, 614.

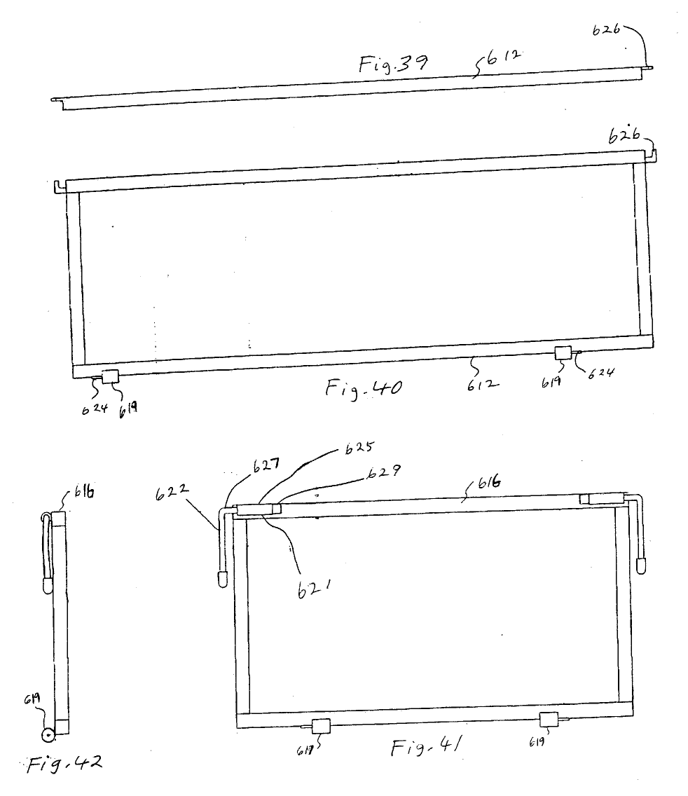

FIGS. 39 and 40 show side and bottom views respectively of a side gate 612. FIG. 40 shows a portion 619 of the hinge 618 attached to the side gate 612 and a hinge pin 624 of the hinge 618. The hinge pin 624 is tapped into the hinge parts 619, 623 (FIG. 38) when the hinge parts 619, 623 are aligned to assemble the hinge 618. FIGS. 39 and 40 also show the side gate 612 has a catch 626.

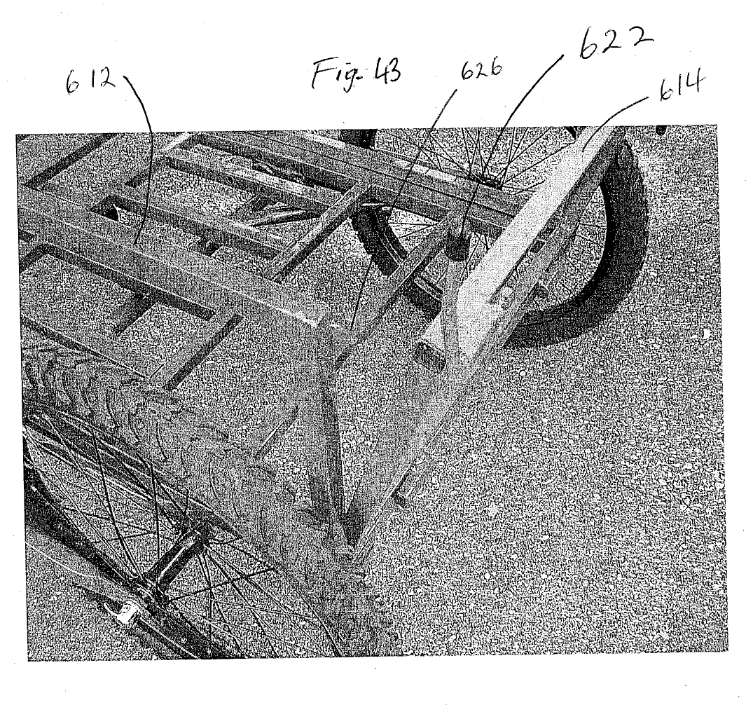

FIGS. 41 and 42 show front and side views of the parts used for the front gate 616. The rear gate 614 and front gate 616 are identical. FIGS. 41 and 42 show the latch 621 having a cylinder 627, a holder 625 and a handle 622. As seen in FIG. 41 an end 629 has a larger diameter than the position within the holder 625.

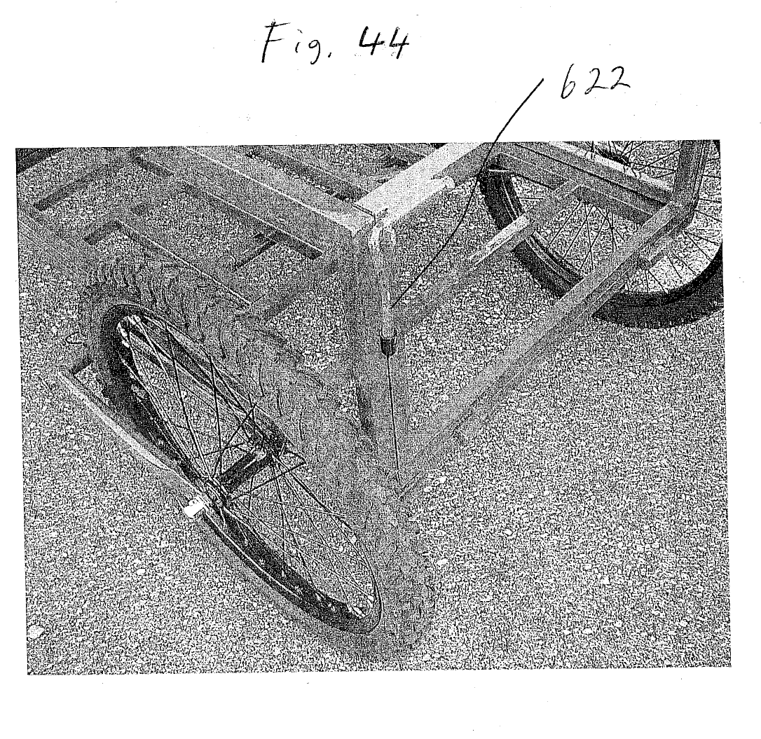

To attach the sidewalls 612 with the rear wall 614 and front wall 612 are performed in substantially the same manner. For example, to close the rear wall 614, the latch cylinder 627 is initially pushed into the latch holder 625 so that the latch handle 622 substantially abuts the latch holder 625 as shown in FIG. 43. The rear wall 614 is then pivoted up to be alongside the sidewall 612. FIG. 43 shows the rear wall 614 being pivoted upwardly. Then when the rear wall 614 is alongside the side wall 612 the latch handle 622 is pulled outwardly to draw the handle beyond the catch 626 and then the latch handle 622 is rotated downwardly to lock the rear wall 614 in place as shown in FIG. 44.

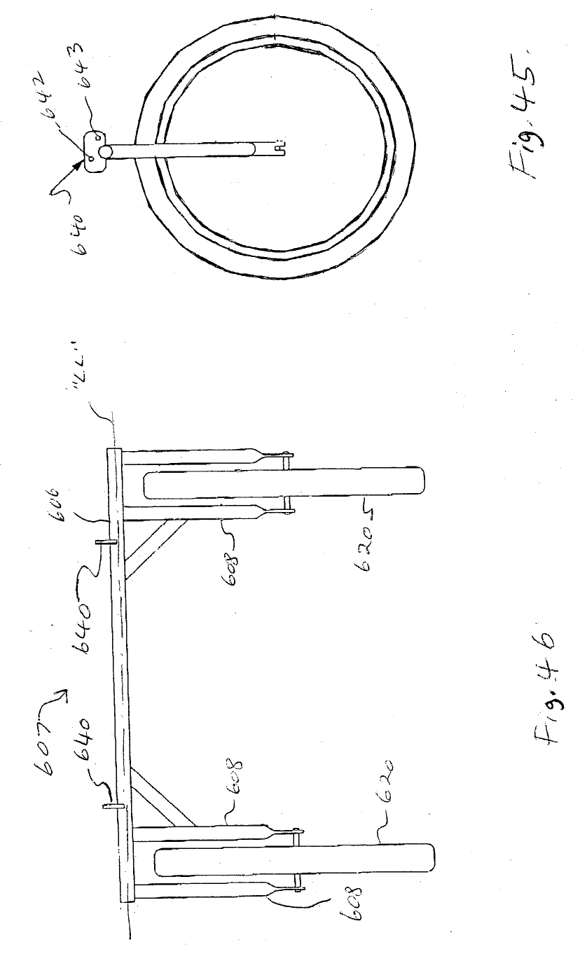

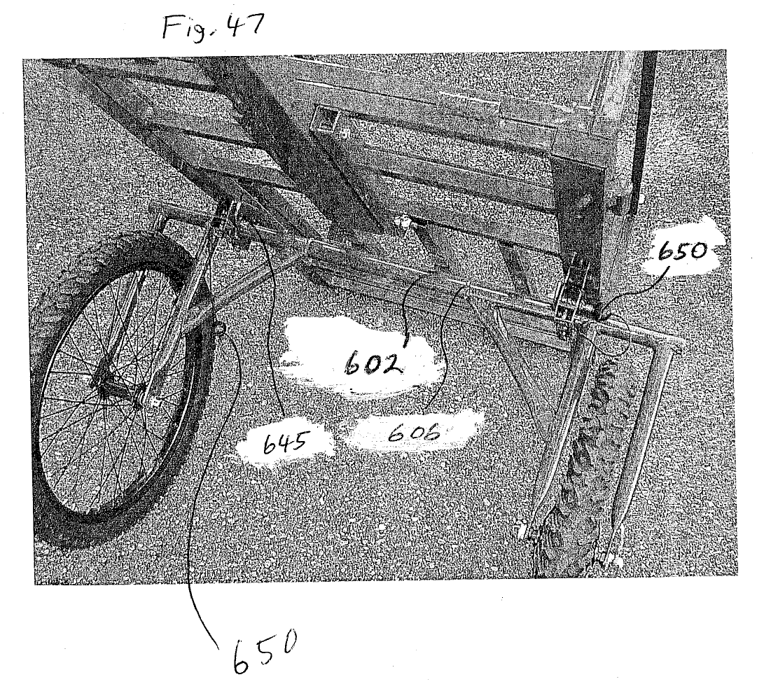

As mentioned above, the rod 606 of the fork assembly is rotatably mounted within mounts 628, 630. FIGS. 45 and 46 show an embodiment of the fork assembly 607 that includes locking plates 640 attached to the rod 606. Each locking plate 640 has holes 642, 643 and is located within a respective mount 628, 630. The holes 642, 643 correspond to the “cart-up” and “cart-down” positions, respectively. When the cart 600 is in the “cart-up” position, hole 642 is aligned with a pair of holes 645 (one shown in FIG. 47) on opposed sides of the respective mount 628, 630 and, for each mount/plate combination, a pin 650 (FIG. 47) passes through the first hole of the pair of holes 645, the hole 642 and the second hole of the pair of holes 645 to lock the cart 600 in the “cart-up” position (see FIG. 45). Likewise, when the cart 600 is in the “cart-down” position, hole 643 is aligned with the pair of the holes 645 on opposed sides of the respective mount 628, 630 and for each mount/plate combination a pin 650 passes through the first hole of the pair of holes 645, the hole 643 and the second hole of the pair of holes 645 to lock the cart 600 in the “cart-down” position.

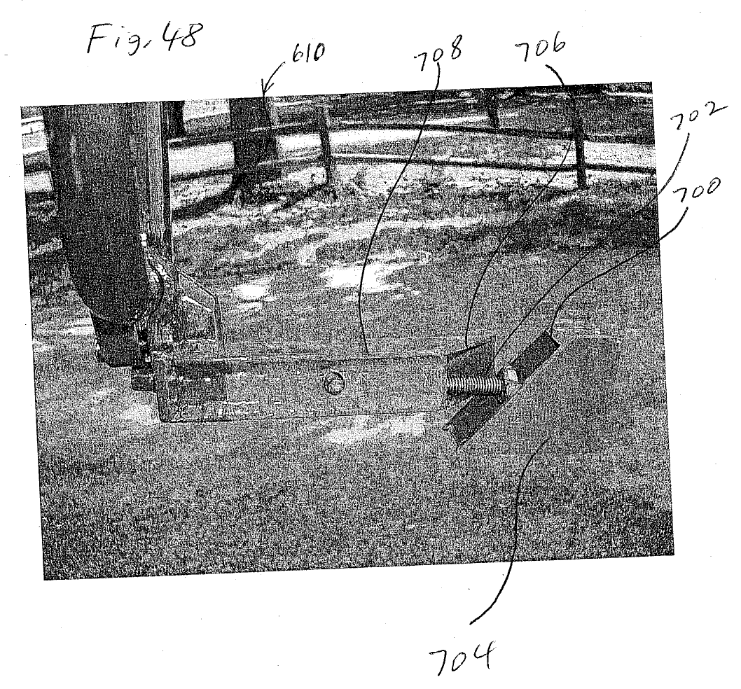

As shown in FIG. 48 the handlebar assembly 610 is held in place in the longitudinal handle 604 by a wedge mechanism 700. As a bolt 702 is tightened, a trapezoidal block 704 slides along an inclined (cam) surface 706 of a stem 708 to jam the block 704 against one inside wall of the longitudinal handle 604 and jam the stem 708 against an opposed inside wall of the longitudinal handle 604 thereby holding the stem 708 in place.

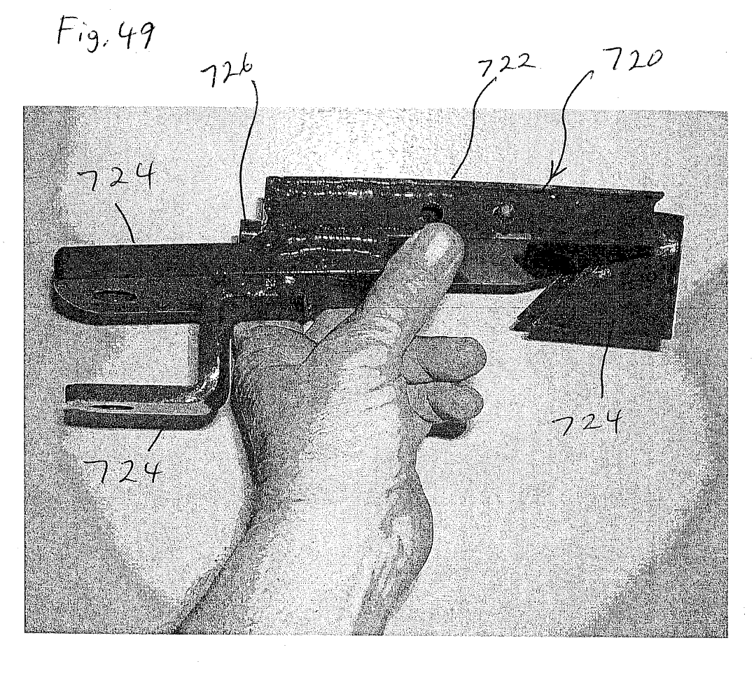

FIG. 49 shows a hitch 720 for inserting into the longitudinal handle 604 such that the cart 600 can be hitched to an all terrain vehicle. The hitch 720 has a stem 722 and tongues 724. The hitch is held tightly in the longitudinal handle by a trapezoidal wedge (block) 724 sliding along an inclined end of the stem 722 when a bolt 726 is tightened as described above for the handlebar assembly 610.

FIGS. 50-52 show a fabric liner 540 for employing with the cart 600. The liner 540 includes strips of hook fabric 542, strips of loop fabric 543 and cutouts 544. The strips 542, 543 are typically VELCRO material and located about the perimeter of inner walls of the liner 540 so that the edges of the liner may be looped over the upper longitudinal member 650 or upper transverse member 652 and each strip 542 interlocks with a respective strip 543 to hold the liner 540 in place in the basket.

The cutouts 544 of the liner 540 provide a location to place saddlebags (not shown).

As shown in FIG. 51, the liner 540 may be provided with a side pocket 546 to hold a rifle or shotgun. As shown in FIG. 52, the liner 540 may also be provided with a side pocket 547 with a zipper 548. If desired, the liner 540 may also be provided with VELCRO lined straps 549 (FIG. 51) for wrapping about a respective longitudinal members 601, and transverse members 602, of platform 603 of the cart 600.

If desired zippers or snaps (not shown) may replace the VELCRO fastener strips 542, 543 for attaching the liner 540 to the cart 400.

The above-described first embodiment of the liner 530 (FIG. 16) could be attached to the cart 600 in essentially the same manner as described for the above-described second embodiment of the liner 540.

For the above-described embodiments, the platform typically has a length of about 30 to 52 inches, a width of about 20 to about 36 inches and the platform lower surface is about 12 to about 30 inches above the ground. Desirably the platform upper surface is flat and when the platform upper surface and longitudinal handle are horizontal, the transverse handle has an uppermost portion about 5 to about 12 inches higher than the platform upper surface, typically about 6 to about 8 inches higher than the platform upper surface. Typically, in the “cart up” position, there are no elements of the cart between the wheel supports in a space of from ground level to a height of at least about 50%, typically at least about 75% of the height of the platform lower surface above the ground level.

It should be apparent that embodiments other than those specifically discussed above come within the spirit and scope of the present invention. Thus, it is apparent that the present invention is not limited by the above-discussed embodiments but rather is defined by the claims appended hereto.

What is claimed is:

1. A utility cart comprising:
a platform having a front end, a back end, and defining an upper surface and a lower surface, the lower surface lying on a lower plane, and said platform having a longitudinal axis;
a straight longitudinal handle extending in a longitudinal direction from the platform, the longitudinal handle having a distal end and a proximal end relative to the platform;
a transverse handle extending transversely from the distal end of the longitudinal handle, wherein the transverse handle comprises a U-shape portion having two opposed ends; and
wheel supports extending downwardly from the platform lower plane, the wheel supports comprising two prongs functionally attached to the platform;
a respective wheel rotatably mounted to each wheel support with one prong on each side of the wheel, each wheel mounted for the cart to travel in the longitudinal direction, the wheels at least partially located beneath the platform lower plane; and
a basket comprising elongate vertical supports, upper longitudinal members and upper transverse members, the vertical supports are functionally attached to the platform and extend upwardly relative to the platform, each vertical support is attached to or integral with at least one member of the group consisting of the upper longitudinal member and the upper transverse member.

2. The cart of claim 1, wherein the vertical supports are attached at the corners of the platform and extend upwardly,

3. The cart of claim 2, wherein each upper longitudinal member is attached to two vertical supports, and each upper transverse member is attached to two vertical supports.

4. The cart of claim 1, wherein at least one member of the group consisting of the upper longitudinal members and the upper transverse members is attached to the vertical supports by expansion bolts.

5. The cart of claim 1, wherein each vertical support is attached to the platform by a respective expansion bolt.

6. The cart of claim 1, wherein an upper portion of the vertical support has opposed holes and a square nut is contained in an end of at least one member of the group consisting of the longitudinal member of the basket and the vertical member of the basket, and the member is attached to the vertical support by screwing a bolt through the opposed holes into the square nut.

7. The cart of claim 1, further comprising a fabric liner releasably attached to the basket to line the basket.

8. The cart of claim 1, further comprising a fabric liner releasably attached to the basket to line the basket, the fabric liner comprising strips of hook shaped fasteners and strips of loop shaped fasteners attached to sidewalls of the fabric liner at locations such that the cover perimeter is wrapable about the longitudinal members and transverse members of the basket and mate to releasably attach the fabric liner to the basket.

9. The cart of claim 8, wherein the fabric liner has pockets.

10. The cart of claim 1, further comprising a fabric floor releasably attached to the platform.

11. The cart of claim 1, further comprising a kick stand allowing for a free standing, horizontally level cart; wherein the transverse handle further comprises a curved handle bar assembly allowing the load to remain in a horizontal position during operation.

12. The cart of claim 1, wherein the kickstand is pivotally attached to said longitudinal handle, said kickstand comprising an upper cylinder having a sidewall having a first hole in an upper portion of the sidewall and a second hole in a lower portion of the sidewall, and an extension slidably mounted within the upper cylinder to be movable between a retracted position and an extended position, a spring loaded protrusion protruding from an upper portion of the extension and engaging the first hole when the extension in is the retracted position and engaging the second hole when the extension in is the extended position.

13. The cart of claim 1, wherein the transverse handle is attached to a transverse handle mount comprising front and rear opposed members holding the handle therebetween, and a handle mount stem is attached to the rear transverse handle mount member, the stem is located within the distal end of the longitudinal handle and had a rectangular transverse cross-section optionally having longitudinal grooves in the perimeter of the stem, the distal end of the longitudinal handle has two opposed holes and the handle mount stem has a transverse passageway located to be aligned with the opposed holes of the longitudinal handle, an elongate member is located within the opposed holes of the longitudinal handle and the transverse passageway of the handle mount stem.

14. The cart of claim 13, wherein the elongate member comprises a head, a stem and a U-shaped wire and has a first end and a second end, the first end comprises the head, the U-shaped wire has a wire first end attached to the head and a wire second end encircling the second end of the stem.

15. The cart of claim 1, wherein the platform upper surface is flat and when the platform upper surface and longitudinal handle are horizontal, the transverse handle has an uppermost portion about 5 to about 12 inches higher than the platform upper surface.

16. The cart of claim 1, wherein the basket comprises a front gate, a back gate and side gates, the front gate comprising one said upper transverse member and two said vertical supports, the rear gate comprising one said upper transverse member and two said vertical supports, and each side gate comprising one said upper longitudinal member and two said vertical supports, the front gate is attached to the platform and the side gates, the rear gate is attached to the platform and the side gates.

14. The cart of claim 1, wherein the front gate, back gate and side gates are pivotally attached to the platform.

15. The cart of claim 1, wherein the front gate, back gate and side gates are pivotally attached to the platform by hinges.

16. The cart of claim 1, wherein the front gate and back gate each further comprise a respective lower transverse member attached to the respective vertical supports of the front gate and back gate, and the side gates each further comprise a respective lower longitudinal member attached to the respective vertical supports of the side gates and the front gate, back gate and side gates are pivotally attached to the platform by hinges attached to the respective lower longitudinal members and lower transverse members.

17. The cart of claim 13, wherein a latch is mounted to a first member of the group consisting of the front gate and the side gate and a catch for engaging the latch to releasably lock the front gate to the side gate is mounted to another member of the group consisting of the front gate and the side gate.

18. The cart of claim 13, wherein the latch comprises a cylinder and a handle extending from the cylinder, the cylinder mounted to reciprocally slide along the longitudinal axis of the latch to releasably engage the latch.

19. The cart of claim 1, wherein the wheel supports comprise a rod rotatably functionally mounted to the platform and two forks per wheel, each fork comprising two prongs extending from the rod perpendicular to a longitudinal axis of the rod.

20. The cart of claim 1, comprising a mount for the transverse handle, the mount for the transverse handle comprises a stem having a first inclined surface, a block having a second inclined surface and a bolt passing through the stem, the first inclined surface, the second inclined surface, and being threaded into the block,
wherein the transverse handle is attached to a first end of the stem, the stem and block are located within the distal end of the longitudinal handle, and a second end of the stem opposed to the first end of the stem comprises the first inclined surface which contacts the second inclined surface of the block,
the second inclined surface is mounted to slide along the first inclined surface of the stem when the bolt is tightened to join the block against one inside wall of the longitudinal handle and jam the stem against an opposed inside wall of the longitudinal handle thereby holding the stem in place.

21. A utility cart comprising:
a platform having a front end, a back end, and defining an upper surface and a lower surface;
a longitudinal handle extending in a longitudinal direction from the platform, the longitudinal handle having a distal end and a proximal end relative to the platform and being parallel to a longitudinal axis of the platform;
a distal member selected from the group consisting of a transverse handle extending transversely from the distal end of the longitudinal handle and a hitch for attaching the cart to a vehicle;
wheels;
wheel supports comprising a rod rotatably functionally mounted to the platform and two forks per wheel, each fork comprising two prongs extending from the rod perpendicular to a longitudinal axis of the rod, each prong having a first end and a second end, said first prong end attached to the rod and each of said wheels rotatably mounted to a respective pair of second prong ends, the rotatable rod being rotatable to pivot the prongs from a first position, wherein the prongs are generally perpendicular to the longitudinal axis of the platform, to a second position, wherein the prong second ends are closer to the platform than in the first position;
each wheel mounted for the cart to travel in the longitudinal direction; and
a kickstand extending downwardly from the longitudinal handle.

22. The cart of claim 21, wherein the rod has sidewalls and two plates extending from the rod sidewalls to between opposed walls of respective rod mounts, the plates having two holes, the rod mounts attached to a bottom side of the platform, the plates each having two holes and each of the walls of the opposed rod mounts having a hole, wherein each said rod mount hole is aligned with each other said rod mount hole and a first of the two plate holes when the prongs are in the first position and the second of the plate holes when the prongs are in the second position.

23. The cart of claim 21, wherein the rod extends sufficiently transversely of the platform that the wheels are lateral of the platform, so the rod may rotate to move the wheels between the first and second positions with the wheels outside the perimeter of the platform.

24. The cart of claim 21, wherein the distal member is the transverse handle and is mounted to the longitudinal handle by a transverse handle mount;
the transverse handle mount comprises a stem having a first inclined surface, a block having a second inclined surface and a bolt passing through the stem, the first inclined surface, the second inclined surface, and being threaded into the block,
wherein the transverse handle is attached to a first end of the stem, the stem and block are located within the distal end of the longitudinal handle, and a second end of the stem opposed to the first end of the stem comprises the first inclined surface which contacts the second inclined surface of the block,
the second inclined surface is mounted to slide along the first inclined surface of the stem when the bolt is tightened to join the block against one inside wall of the longitudinal handle and jam the stem against an opposed inside wall of the longitudinal handle thereby holding the stem in place.

25. The utility cart of claim 21, wherein the distal member is the hitch, and the hitch comprises a stem and two tongues protruding from a distal end of the stem, each tongue having a hole and the tongue holes being aligned.

26. A utility cart comprising:
a platform having a front end, a back end, and defining an upper surface and a lower surface;
a longitudinal handle extending in a longitudinal direction from the platform, the longitudinal handle having a distal end and a proximal end relative to the platform;
a hitch for attaching the cart to a vehicle, the hitch comprising a stem having a longitudinal axis, an extension having a proximal end and a distal end relative to the stem, the extension comprising a majority portion having an angle “A” of about 120 degrees to about 150 degrees relative to a longitudinal axis of the stem, at least one tongue extends from the distal end of the extension and has a hole therethrough for accepting a pin to attach the hitch to a vehicle;
wheel supports attached to the platform;
a respective wheel rotatably mounted to each wheel support, each wheel mounted for the cart to travel in the longitudinal direction; and
a basket comprising a front gate, a rear gate, and side gates, the front gate is attached to the platform and the side gates, the rear gate is attached to the platform and the side gates.

27. The cart of claim 26, wherein the hitch has two tongues, the tongues are parallel to the longitudinal axis of the stem, and the hitch is further attached to the platform by braces, each brace having first and second ends, wherein a first brace end is attached to the hitch and the second brace end is attached to the platform.

28. A hand operated utility cart comprising:
a platform having a front end, a back end, and defining an upper surface and a lower surface;
a handle comprising a longitudinal handle member extending in a longitudinal direction from the platform, the longitudinal handle having a distal end and a proximal end relative to the platform and a transverse handle member extending transversely from the distal end of the longitudinal handle member;
wheel supports extending downwardly from the platform lower surface;
a respective wheel rotatably mounted to each wheel support, each wheel mounted for the cart to travel in the longitudinal direction; and
a kickstand;
wherein the platform upper surface is flat and when the platform upper surface and longitudinal handle are horizontal, the transverse handle has an uppermost portion about 5 to about 12 inches higher than the platform upper surface.

29. An expandable insert comprising a bolt, a first threaded nut, a second unthreaded nut and a rubber washer, the first threaded nut, the second unthreaded nut and the rubber washer are located on the washer with the rubber washer between the threaded nut and an unthreaded nut, each nut and the rubber washer having a perimeter having at least two opposed flat sides, wherein the perimeter of the rubber washer is insert at most 1/16 inch relative to the perimeter of the respective nuts.

30. The expandable insert of claim 29, wherein the perimeter of the rubber washer is insert 10/1000 to about 1/64 inch relative to the perimeter of the respective nuts and the rubber washer is attached to the nuts.

31. The expandable insert of claim 29, wherein opposed walls of nuts have hollows and the rubber washer is seated in the hollows.

32. A utility cart comprising:
a platform having a front end, a back end, and defining an upper surface and a lower surface, the lower surface lying on a lower plane, and said platform having a longitudinal axis;
a straight longitudinal handle extending in a longitudinal direction from the platform, the longitudinal handle having a distal end and a proximal end relative to the platform, the longitudinal handle and the platform being parallel;
a transverse handle extending transversely from the distal end of the longitudinal handle, wherein the transverse handle comprises a U-shape portion having two opposed ends, wherein the two opposed ends are about 5 to about 12 inches higher than the longitudinal handle when the longitudinal handle is in a horizontal position; and
wheel supports extending downwardly from the platform lower plane, the wheel supports comprising two prongs functionally attached to the platform;
a respective wheel rotatably mounted to each wheel support with one prong on each side of the wheel, each wheel mounted for the cart to travel in the longitudinal direction, the wheels at least partially located beneath the platform lower plane.
